(19) United States
(12) Patent Application Publication
(10) Pub. No.: US 2026/0272767 A1
(43) Pub. Date: Sep. 17, 2026

(54) EJACULATION-PROMOTING DEVICE

(71) Applicant: HYTTO PTE. LTD, Singapore (SG)

(72) Inventors: Dan LIU, Singapore (SG); Jilin QIU, Singapore (SG); Zhiwen WU, Guangzhou (CN)

(73) Assignee: HYTTO PTE. LTD, Singapore (SG)

(21) Appl. No.: 19/685,564

(22) Filed: May 22, 2026

Related U.S. Application Data
(63) Continuation-in-part of application No. PCT/IB2024/061704, filed on Nov. 22, 2024.

(30) Foreign Application Priority Data
Nov. 24, 2023 (CN) 202323180770.2

(51) Int. Cl. A61H 19/00

(52) U.S. Cl. CPC A61H 19/32; A61H 2201/0107; A61H 2201/0119; A61H 2201/0153; A61H 2201/1215; A61H 2201/149; A61H 2201/1664

(57) ABSTRACT

The disclosure relates to an ejaculatory stimulation device for medical semen collection and personal-use hygiene applications. Conventional devices may be prone to accidental detachment during operation and may be inconvenient to disassemble for cleaning or replacement. The device includes a drive assembly with an exterior contact surface and a detachable movable assembly having a massage member with a massage channel, where the movable assembly reciprocates along a first direction aligned with an inserted phallic structure to provide frictional stimulation, and is released from the drive assembly by movement in a different second direction, such as rotation, while remaining outside the housing. This arrangement can improve operational stability, facilitate removal and maintenance, and help reduce liquid ingress into the drive assembly.

### CROSS REFERENCE TO RELATED APPLICATIONS

This application is a Continuation-in-Part Application of International Patent Application Number PCT/IB2024/061704 filed Nov. 22, 2024, which claims the benefit of priority of Chinese Patent Application Number 202323180770.2 filed Nov. 24, 2023, the entire disclosure of both of which is incorporated herein by reference.

### FIELD OF THE INVENTION

The present invention generally relates to intimate stimulation devices and, more particularly, to an ejaculatory stimulation device having a drive assembly and a removable movable assembly configured to provide stimulation to a phallic structure, while facilitating attachment, detachment, cleaning, replacement, and hygienic use.

### BACKGROUND OF THE INVENTION

Devices for stimulating a male human organ and, in some cases, collecting semen have been used in connection with medical examination, fertility-related procedures, research, personal care, and other private applications. Such devices may be used in clinical environments or in home environments, and may be configured for single-use, reusable, or partially replaceable operation.

Existing stimulation devices commonly include a housing, a stimulation sleeve, and a drive mechanism configured to transmit motion to the stimulation structure. In some arrangements, a stimulation component is mounted within a housing cavity, while in other arrangements a removable stimulation module is connected to a drive portion. Certain devices further provide replaceable sleeves or liners to facilitate hygiene, maintenance, or customization.

However, conventional devices may still present various practical challenges. For example, repeated operation may cause loosening, instability, vibration offset, or wear in the connection relationship between a stimulation structure and a drive structure. In some implementations, cleaning and replacement procedures may be inconvenient, particularly where internal drive components are positioned near regions exposed to liquids or bodily fluids. In other implementations, motion transmission structures may be susceptible to contamination, leakage, or durability issues after repeated use.

Additionally, some conventional structures may provide insufficient support or guidance for a movable stimulation assembly during movement, which can negatively affect operational smoothness, user comfort, or motion stability. Certain devices may also provide limited adaptability with respect to installation, replacement, ergonomic contouring, or structural maintenance.

Accordingly, there remains a need for improved stimulation devices and related structures that can provide reliable motion transmission, facilitate maintenance and component replacement, improve operational stability and hygiene performance, and enhance user convenience and comfort.

### SUMMARY OF THE INVENTION

In one aspect, the invention provides an ejaculatory stimulation device including a drive assembly and a movable assembly detachably coupled to an exterior contact surface of the drive assembly, wherein the movable assembly is driven to move along a first direction to provide frictional stimulation to a phallic structure received within a massage channel.

In another aspect, the invention provides coupling, sealing, support, and contour features that may improve attachment stability, ease of removal, hygiene, and user comfort, and which may be implemented in different combinations in various system, method, and component embodiments.

### BRIEF DESCRIPTION OF THE DRAWINGS

FIG. 1 is a schematic perspective view of an ejaculatory stimulation device according to one embodiment, showing a drive assembly and a movable assembly in a coupled state.

FIGS. 2 and 3 are exploded schematic views of the drive assembly from different directions.

FIG. 4 is a schematic side view of the device of FIG. 1, illustrating reciprocating movement of the movable assembly along a first direction an exploded schematic view of the movable assembly.

FIG. 5 is a cross-sectional view of the massage member.

FIG. 6a is a schematic side view of the device of FIG. 1, illustrating sliding movement of the movable assembly along a first direction.

FIG. 6b is a schematic view illustrating release of the movable assembly relative to the drive assembly along a second direction different from the first direction of sliding movement.

FIG. 7a is a schematic side view of the device of FIG. 1, illustrating rotating movement of the movable assembly along a first direction.

FIG. 7b is a schematic view illustrating release of the movable assembly relative to the drive assembly along a second direction different from the first direction of rotating movement.

FIGS. 8 and 9 are schematic views of one detachable coupling arrangement employing a protrusion and a corresponding connecting groove.

FIG. 10 is a schematic view of a massage member having a head portion, a body portion, an annular groove, and external protruding ribs.

FIG. 11 is a schematic view of the structure of the upper mounting bracket (with deformable portion).

FIG. 12 is a schematic view of the installation structure of the lower mounting bracket and its components.

FIG. 13 is a schematic view of an embodiment further including a third end cover having a second concave curved surface for providing clearance.

FIG. 14 is a schematic perspective view of an ejaculatory stimulation device according to another embodiment, showing a fixing component assembled with the drive assembly and the movable assembly.

FIG. 15 is a schematic view of the structure of the fixing component.

FIGS. 16 and 17 are exploded schematic views of the fixing component from different directions.

FIG. 18 is a schematic view of the locking plate structure.

### DETAILED DESCRIPTION OF THE INVENTION

Reference will now be made in detail to various embodiments of the invention, examples of which are illustrated in the accompanying drawings. Wherever possible, the same reference numerals are used throughout the drawings and description to refer to the same or like parts. It should be understood that the drawings are schematic and not necessarily to scale. The described embodiments are illustrative rather than limiting, and features of different embodiments may be combined unless clearly incompatible.

As used herein, directional terms such as “first,” “second,” “axial,” “longitudinal,” “circumferential,” “radial,” “inner,” “outer,” “upward,” and “downward” are used for convenience of description with reference to the illustrated examples and do not necessarily require a particular orientation in use. The term “phallic structure” is intended to broadly encompass a penis or another elongate anatomical structure or model to be stimulated, treated, examined, or otherwise received by the device. The term “massage member” is intended to broadly encompass a sleeve, liner, insert, stimulation body, elastomeric member, or another structure defining a receiving channel. The term “drive assembly” is intended to broadly encompass any powered or manually assisted structure that imparts motion to a movable assembly. The term “processor,” “controller,” “memory,” and “communication unit” are used broadly and can include one or more discrete or integrated devices.

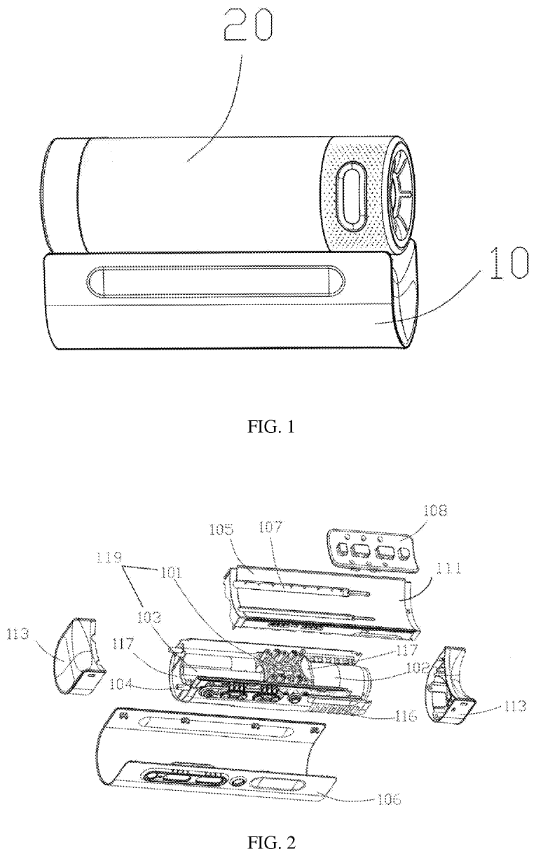

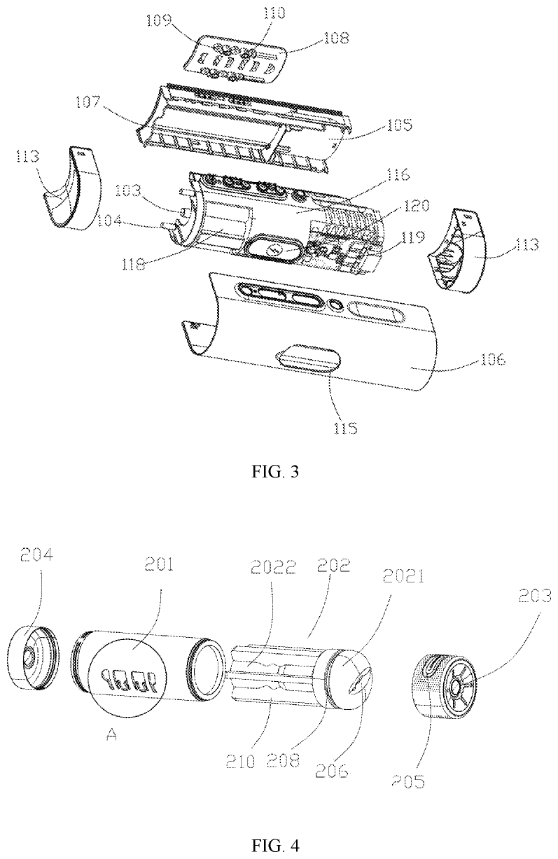

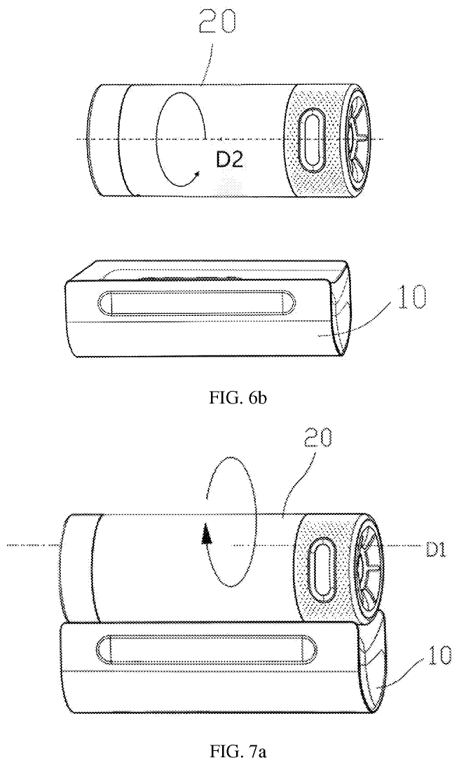

In one aspect, the invention provides an ejaculatory stimulation device 100 including a drive assembly 10 and a movable assembly 20, as generally shown in FIG. 1. The drive assembly 10 may include a housing 106 having an exterior contact surface 111 extending along a first direction D1, as illustrated in FIG. 2. The movable assembly 20 may include a massage member 202 having a massage channel 211 dimensioned to accommodate a phallic structure and an insertion opening 206 configured to permit the phallic structure to enter and exit the massage channel 211, as illustrated in FIGS. 3-4. The movable assembly 20 may be detachably coupled to the exterior contact surface 111 of the drive assembly 10 by a detachable coupling 40 so as to define a coupled state. In the coupled state, the movable assembly 20 is configured to slide along the exterior contact surface 111 in the first direction D1 under driving of the drive assembly 10, as illustrated in FIG. 6a, thereby causing the massage channel 211 to stimulate the phallic structure.

In some embodiments, the first direction D1 is aligned with, substantially aligned with, or generally parallel to an axial direction of the phallic structure inserted into the massage channel 211. In this manner, stimulation may be generated by repeated relative movement in a lengthwise direction corresponding to an insertion direction of the phallic structure. In other embodiments, the first direction D1 may be slightly inclined relative to the axial direction, for example within 1-20 degrees, within 2-15 degrees, or within 3-10 degrees, while still achieving a desired sliding frictional effect.

The movable assembly 20 is further configured to be removed from the drive assembly 10 by movement along a second direction D2 different from the first direction D1, as illustrated in FIG. 6b. In one preferred embodiment, the second direction D2 is a rotational direction. In such embodiment, the movable assembly 20 may be released from the detachable coupling 40 after rotating relative to the drive assembly 10 by a predetermined angle, for example approximately 5-120 degrees, optionally 10-90 degrees, optionally 15-60 degrees. By arranging removal movement along a direction different from the sliding drive direction, accidental decoupling during sliding operation may be reduced while preserving convenient user-initiated disassembly.

In some embodiments, the rotational movement along the second direction D2 comprises circumferential rotation about an axis of the movable assembly 20, wherein the axis of the movable assembly 20 is substantially parallel to the axial direction of the inserted phallic structure. In other embodiments, the rotational movement may comprise circumferential rotation about a position point or local region on the exterior contact surface 111 as a center or virtual pivot point. In still other embodiments, the second direction D2 may be substantially perpendicular to the first direction D1, or may form another predetermined angle relative thereto, such as 30 degrees, 45 degrees, 60 degrees, 75 degrees, or 90 degrees. In further alternatives, the second direction D2 may include translational release, pivotal release, cam-guided release, flexural release, or a compound movement including both translation and rotation.

In one embodiment, the detachable coupling 40 may be formed by snap engagement. In another embodiment, the detachable coupling 40 may be formed by threaded engagement. In still another embodiment, the detachable coupling 40 may be formed by bayonet engagement, hook-and-slot engagement, tongue-and-groove engagement, magnetic retention supplemented by mechanical positioning, latch engagement, detent engagement, or another releasable mechanical interface. Optionally, the coupling may include a primary locking structure and a secondary anti-separation structure. Preferably, the movable assembly 20 remains entirely outside the housing 106 of the drive assembly 10 during sliding motion. This exteriorly supported arrangement may facilitate cleaning, isolate internal drive components from direct contact with fluids, and enable rapid exchange of movable assemblies or massage members having different properties.

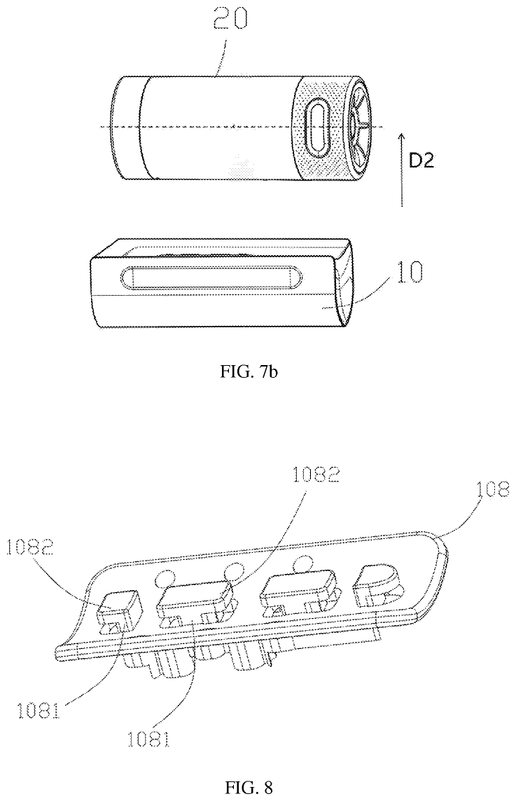

A further implementation variant will now be described. Referring to FIG. 7a, in some embodiments, the drive unit is configured to rotationally drive at least a portion of the movable assembly 20 relative to the housing 106 along the first direction D1, rather than linearly sliding the movable assembly 20. In such embodiments, the movable assembly 20 may still remain detachably coupled to the drive assembly 10 while being supported by the exterior contact surface 111. The first direction D1 may correspond to an axial direction of the phallic structure received within the massage channel 211, and the rotational motion may occur about an axis substantially parallel to the first direction D1.

In one embodiment, the drive assembly 10 includes a rotary motor disposed within the housing 106. An output shaft of the rotary motor extends outwardly from the housing 106 toward the movable assembly 20. The output shaft may pass through an opening, bearing structure, or sealed interface formed in the housing 106 and may be coupled to the movable assembly 20 through a detachable coupling structure. In some embodiments, the output shaft extends into the container of the movable assembly 20 and is operatively coupled to the container so as to rotationally drive the movable assembly 20 about the first direction D1.

In some embodiments, the output shaft is coupled directly to the container such that the container rotates relative to the housing 106. In still further embodiments, the container itself may include an internal rotating stimulation structure configured to rotate relative to another portion of the container.

The detachable coupling between the output shaft and the movable assembly 20 may comprise a bayonet coupling, spline coupling, keyed coupling, polygonal shaft coupling, threaded coupling, snap-fit coupling, or another releasable torque-transmitting structure. In one embodiment, the output shaft includes one or more protrusions configured to engage corresponding grooves formed in the movable assembly 20. By rotating the movable assembly 20 relative to the drive assembly 10 by a predetermined angle, the protrusions may enter locking portions of the grooves so as to establish a torque-transmitting connection. Correspondingly, reverse rotation in the second direction D2 may release the coupling and permit removal of the movable assembly 20 from the drive assembly 10, as illustrated in FIG. 7b.

In some embodiments, the second direction D2 for decoupling is different from the rotational driving direction of the drive unit during operation. For example, the movable assembly 20 may be detached by axial pulling, radial displacement, pressing of a release member, deformation of a resilient latch, or another non-operational release action. In other embodiments, the movable assembly 20 may be detached through relative rotation exceeding a predetermined release angle different from an operational rotation range generated by the rotary motor 130. By differentiating the operational driving movement from the decoupling movement, unintended separation during operation may be reduced.

In some embodiments, the sliding implementation and the rotational implementation may be selectively interchangeable. For example, different movable assemblies 20 may be detachably mounted to a common drive assembly 10, wherein a first movable assembly is configured for sliding stimulation and a second movable assembly is configured for rotational stimulation. In other embodiments, the drive assembly 10 may include both a reciprocating drive mechanism and a rotary drive mechanism, and a controller may selectively activate one or both mechanisms according to a selected operating mode.

Referring to FIGS. 2-3, in some embodiments the housing 106 has an elongated hole 107. The drive assembly 10 may include a drive unit, at least a portion of which is located within the housing 106. A portion of the drive unit located outside the housing 106 may pass through the elongated hole 107 and couple with the movable assembly 20. The outside portion may slide along the elongated hole 107 to drive the movable assembly 20 and thereby drive the massage channel to reciprocate. The elongated hole 107 may extend along the first direction D1 and may define a stroke length corresponding to a desired reciprocation range.

The stroke length may be selected according to intended application and may, for example, be in a range of about 5 mm to about 150 mm, optionally about 10 mm to about 100 mm, optionally about 20 mm to about 80 mm. The reciprocation frequency may be adjustable and may, for example, range from about 0.2 Hz to about 20 Hz, or may be expressed as about 10 to about 1200 strokes per minute. The drive profile may be sinusoidal, trapezoidal, asymmetric, variable-speed, pulsed, randomized, learned, or user-programmable.

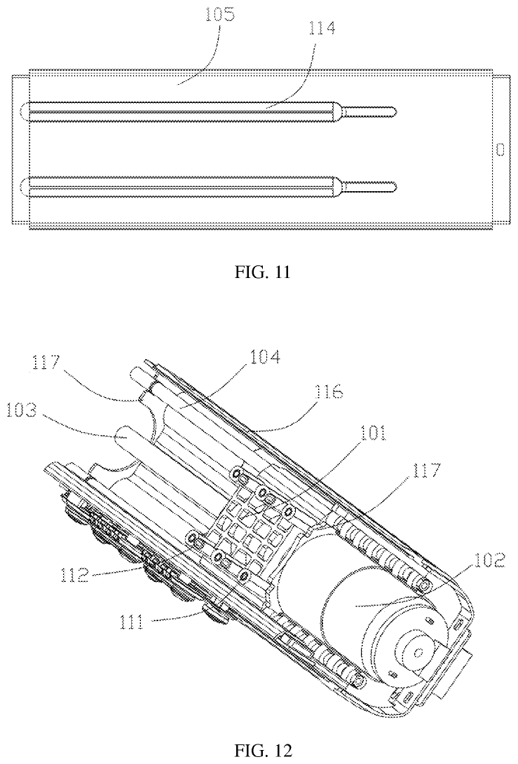

In some embodiments, a deformable member 114 is arranged at an edge of the elongated hole 107, as shown in FIG. 11. The deformable member 114 may be configured to prevent liquid from seeping into an interior of the drive assembly 10 through the elongated hole 107. The deformable member 114 may comprise a flexible lip, membrane, bellows, grommet, elastomeric flap, brush seal, foam seal, overmolded barrier, or multilayer sealing structure. Suitable materials may include silicone, thermoplastic elastomer, rubber, polyurethane, fluoroelastomer, or another compliant material. In some embodiments, the deformable member 114 remains in contact with the moving outside portion of the drive unit while accommodating translation along the first direction D1. In some embodiments, the sealing arrangement can achieve splash resistance, droplet resistance, or higher ingress protection depending on implementation.

The drive unit may take many forms. In one embodiment, the drive unit comprises a motor 102 fixed within the housing 106 and a linear reciprocating mechanism 119 configured to convert rotational motion of an output shaft of the motor into linear reciprocating motion of the outside portion or a connecting member 108, as shown in FIG. 2-3. The linear reciprocating mechanism 119 may include, by way of non-limiting example, a crank-slider mechanism, eccentric wheel mechanism, Scotch yoke mechanism, cam-follower mechanism, lead screw with reversing control, rack and pinion arrangement, linkage assembly, voice-coil actuator, linear motor, solenoid-based arrangement, piezoelectric arrangement, pneumatic actuator, hydraulic actuator, shape-memory actuator, or combinations thereof. In such a case, the linear reciprocating mechanism may include a slider 101 and a screw 103 arranged within the housing. A free end of the output shaft of the motor 102 can be connected to the screw 103. The slider 101 may have a perforation for the screw 103 to pass through, and an inner wall of the perforation is provided with internal threads, or a nut is set within the perforation. When the screw 103 passes through the perforation in the slider 101, it may engage with the internal threads on a wall of the perforation or with the nut in the perforation. Under the drive of the motor 102, the slider 101 reciprocates along the screw 103, with a portion of the slider 101 located inside the housing and another portion outside it. The portion of the slider 101 outside the housing can be connected to the connecting member 108. By transmitting power via the screw 103, the reciprocating motion of the slider 101 becomes smoother and more precise. Additionally, when the motor 102 provides power, the user can set a target rotational speed for the output of the motor 102. By measuring the actual output speed of the motor 102 in real-time and using a PID algorithm, the speed of the motor 102 can be automatically adjusted to maintain the user-defined target speed. This means that when the actual output speed of the motor 102 exceeds the target speed, the speed of the motor 102 may be reduced; when the actual output speed is lower than the target speed, the speed of the motor 102 may be increased. This mechanism aligns with the user's requirements and enhances the overall user experience.

In a preferred electromechanical embodiment, the motor may be a DC motor, brushless DC motor, stepper motor, servo motor, coreless motor, or geared motor. The motor may be powered by a replaceable battery, rechargeable battery, wired power source, docking interface, or external power adapter. The housing 106 may further contain a power source, a controller, and optional user interface elements such as a switch, button, dial, touch region, or wireless communication interface. In some embodiments, a communication unit may permit control via a mobile device, remote device, or clinical workstation. In other embodiments, the device may operate without any wireless features.

In one aspect, the drive assembly 10 may comprise a connecting member 108 located outside the exterior contact surface 111 and coupled with the movable assembly 20. In one embodiment, shown in FIG. 2-3, the connecting member 108 comprises a protrusion, and the movable assembly 20 comprises a connecting groove corresponding to the protrusion. The protrusion is configured to be inserted into the connecting groove to couple the movable assembly 20 with the drive assembly 10. The protrusion and connecting groove may be dimensioned to establish positional indexing, force transmission, and detachable retention.

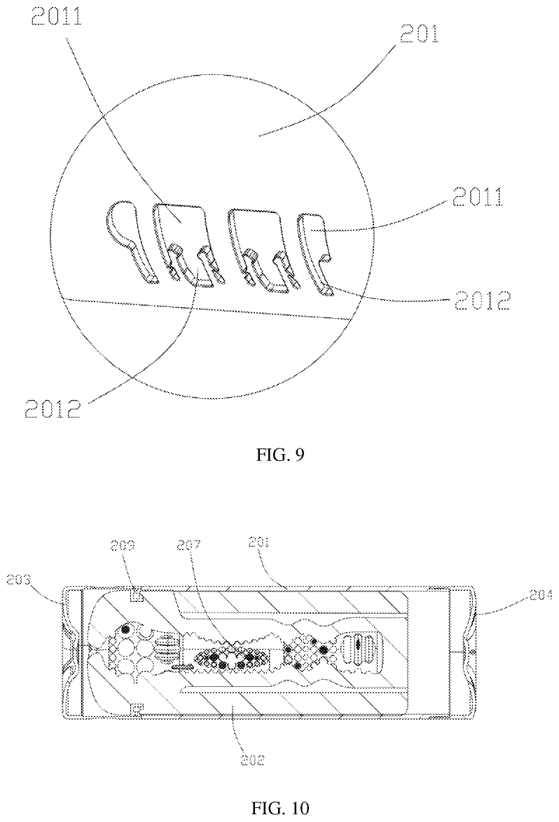

Referring to FIG. 8-9, in a preferred bayonet-type implementation, the protrusion comprises a vertical plate 1081 connected to the connecting member 108 and a horizontal plate 1082 connected to the vertical plate 1081. The horizontal plate 1082 can form either an L-shape or a T-shape with the vertical plate 1081. The number of protrusions can be one or more; in this embodiment, there are four protrusions spaced apart. The movable assembly 20 is provided with connecting grooves that correspond to the number of protrusions, and they align one-to-one. FIG. 9 is a partially enlarged view of part A in FIG. 4, Referring to FIG. 9, the connecting groove comprises an insertion portion 2011 and a clamping portion 2012. When the protrusion is inserted into the connecting groove of the movable assembly 20, the horizontal plate 1082 of the protrusion is inserted through the insertion portion 2011, and by rotating the movable assembly 20 or the drive assembly 10, the vertical plate 1081 rotates and slides from the insertion portion 2011 into the clamping portion 2012, thereby establishing a locked state. Since the clamping portion 2012 is smaller in size than the insertion portion 2011 and the horizontal plate 1082 of the protrusion, it effectively prevents the protrusion from disengaging from the connecting slots. Therefore, the protrusions can be inserted into the connecting grooves to link the movable assembly 20 with the driving assembly 10. The clamping portion 2012 may include a narrowed throat, undercut, shoulder, detent, resilient interference portion, or stop surface for resisting unintended release during reciprocation.

In some embodiments, the protrusion may be metallic, polymeric, ceramic, composite, or overmolded. The connecting groove may be formed integrally with a container 201 of the movable assembly 20, or may be formed by a separate insert fixed to the container 201. The components may be injection molded, machined, cast, printed, stamped, or fabricated by another technique. In one implementation, the protrusion may be stainless steel or reinforced polymer, and the connecting groove may be formed in a rigid polymeric shell. In another implementation, both may be formed in engineering plastic to reduce weight and manufacturing cost.

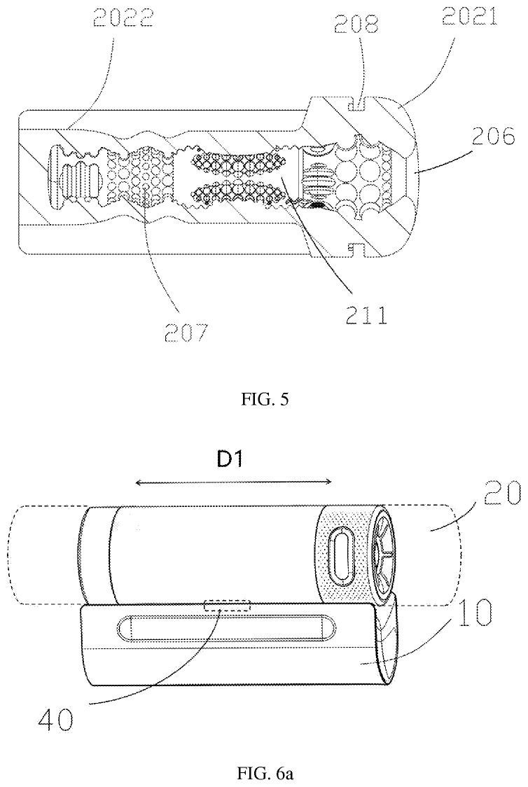

Referring to FIGS. 4-5 and 10, the movable assembly 20 may further comprise a container 201 configured to accommodate and secure at least a portion of the massage member 202, with the insertion opening 206 located outside the container 201. In such a case, the container 201 can be a shape of a cylindrical cup, which can have openings at both ends or only at one end. When there is an opening at only one end, the opening can allow a portion of the massage member 202 to extend outside the container 201. If the container 201 has openings at both ends, one opening can allow a portion of the massage member 202 to extend outside the container 201, while the other opening is spaced from the end of the massage member 202, providing space for the installation of an expansion module, such as a heating element. In the case where the container 201 has one opening, a first end cover 203 is provided at that opening. In the case where both ends of the container 201 have openings, a first end cover 203 can be installed at the opening where the massage member 202 extends, and a second end cover 204 can be installed at the opening on the opposite end, facilitating the assembly and disassembly of the expansion module. The connection manner of the first end cover 203 and the second end cover 204 to the corresponding openings of the container 201 may adopt a threaded connection or a snap-fit connection. Via the combination of the container 201 with the first end cover 203 and the second end cover 204, the massage member 202 can be completely enclosed inside, preventing contamination of the massage member 202 and ensuring its hygiene. Additionally, raised particle portion 205 can be arranged on the lateral walls of either the first end cover 203, the second end cover 204, or both, to increase the friction between the male human's hand and the lateral walls of the end covers, facilitating the rotation or removal of the corresponding end covers. The massage member 202 may comprise a head portion 2021 and a body portion 2022, wherein a size of the body portion 2022 is smaller than a size of the head portion 2021. The insertion opening 206 may be disposed on an end surface of the head portion 2021. An annular groove 208 may be formed on a sidewall of the head portion 2021, and one sidewall of the annular groove 208 may be recessed in a direction away from another sidewall thereof. A port 231 at an end of the container 201 through which the head portion 2021 extends may be provided with an annular inner latch 209. After the massage member 202 is installed in the container 201, a portion of the sidewall of the head portion 2021 is positioned within the container 201 and abuts against an inner wall of the container 201, and the annular inner latch 209 engages the annular groove 208 of the massage member 202. The insertion opening 206 can connect to the massage channel inside the massage member 202, and different shapes of protruding structures 207 are arranged on the wall of the massage chamber. These protruding structures 207 facilitate the stimulation of the phallic structure.

This arrangement may permit the massage member 202 to be removably retained in the container 201 while reducing the likelihood of the massage member 202 being pulled out during use. In some embodiments, the annular inner latch 209 is continuous; in other embodiments it is segmented into a plurality of circumferentially spaced latch portions. The latch may be formed integrally with the container 201 or may be provided by a separate retainer ring. The annular groove 208 may have a sloped wall, stepped wall, rounded wall, or another retaining profile. Optionally, the head portion 2021 may be elastically deformable to snap through the port 231 during installation and removal.

The body portion 2022 of the massage member 202 may be tubular, generally cylindrical, tapered, contoured, lobed, or otherwise shaped. The massage channel 211 may have a smooth inner wall or may include one or more internal features such as ribs, protrusions, spiral ridges, fins, nodules, rings, chambers, flaps, segmented zones, texturing, lubricious coatings, heating elements, thermal reservoirs, or pressure-modulating regions. In some embodiments, the massage channel 211 may have a variable cross-section along its length. In some embodiments, the massage member 202 may be formed from silicone, thermoplastic elastomer, rubber-like polymer, gel material, hydrogel-compatible material, polyurethane, latex-free elastomer, or another deformable and body-compatible material. The hardness may vary, for example in a Shore A range of about 00-80, optionally about 5-50.

In some embodiments, a plurality of protruding ribs 210 are arranged at intervals on an outer sidewall of the body portion 2022 such that, after the massage member 202 is installed in the container 201, the protruding ribs 210 abut against the inner wall of the container 201. The protruding ribs 210 may improve radial support, reduce collapse of the massage member 202 under compression, define drainage paths, reduce contact area for easier removal, or influence transmitted stimulation characteristics. The protruding ribs 210 may be annular, helical, longitudinal, segmented, or discontinuous. In some embodiments, the spacing between ribs may be uniform; in others, it may vary along the length to tune stiffness and compliance.

In some embodiments, the container may be rigid or semi-rigid and may be formed from acrylonitrile butadiene styrene (ABS), polycarbonate, polypropylene, nylon, glass-filled polymer, aluminum, stainless steel, or composite material. In some embodiments, the housing may similarly be rigid and may include one or more shell portions joined by fasteners, snap fits, adhesive bonding, welding, or overmolding. The exterior surfaces may include coatings or textures to improve grip and cleanability. Any user-contacting rigid portions may have rounded edges. The device may be configured for handheld use, tabletop use, supported use, or mounting to another structure.

In one aspect, the invention contemplates multiple separable inventive concepts. A first inventive concept relates to a reciprocating movable assembly located externally of a housing and detachably coupled to an exterior contact surface, where release is effected by movement along a second direction different from the reciprocating direction. A second inventive concept relates to a fluid-protected drive interface including an elongated hole and a deformable sealing member through which an outside drive portion moves while remaining coupled to an external movable assembly. A third inventive concept relates to a container-and-massage-member subassembly having a head portion, annular groove, annular latch, and optional outer ribs for secure retention and support. A fourth inventive concept relates to ergonomic contouring of the housing and adjacent end cover to accommodate anatomy. These concepts may be claimed individually or in combination.

Assembly and use will now be described by way of example. In one exemplary process, a user first selects a massage member 202 having a desired internal texture, stiffness, and channel size. The massage member 202 is inserted into the container 201 so that the head portion 2021 extends through the port 231 and the annular inner latch 209 snaps into the annular groove 208. The movable assembly 20 is then coupled to the connecting member 108 of the drive assembly 10 by insertion and rotation, threaded engagement, or another detachable coupling action. A lubricant may optionally be applied to the massage channel 211 and/or to the phallic structure. The phallic structure is inserted through the insertion opening 206 into the massage channel 211. The device is then operated so that the movable assembly 20 reciprocates along the first direction D1 while being supported externally by the exterior contact surface 111. Following operation, the movable assembly 20 may be uncoupled by movement along the second direction D2 and cleaned, sterilized, discarded, or replaced, depending on the implementation.

In some embodiments, one or more of the dimensions of the massage channel 211 may be selected from a family of sizes. For example, the channel diameter may be in a range of about 15 mm to about 60 mm, and the channel length may be in a range of about 50 mm to about 250 mm. The outer dimensions of the container 201 may be chosen to correspond to the curvature of the exterior contact surface 111. The width of the elongated hole 107 may be selected to permit reliable translation of the outside portion while limiting fluid ingress and mechanical play. It will be appreciated that these dimensions are merely exemplary and may be varied substantially.

In some embodiments, the housing 106 and/or movable assembly 20 may include one or more anti-rotation or anti-rattle features. Such features may include guide rails, side flanges, low-friction liners, wear strips, rollers, pads, magnetic stabilizers, or complementary contoured surfaces. In other embodiments, the movable assembly 20 may be supported by a carriage or sled interposed between the container 201 and the housing 106. In still other embodiments, the movable assembly 20 may include a frame carrying the massage member 202 and the coupling structure. The frame, container, and massage member may be integrated as a single disposable or semi-disposable module.

A first implementation variant will now be described. In a preferred embodiment, the device 100 includes the housing 106, the elongated hole 107, the motor, and the linear reciprocating mechanism 119, with the connecting member 108 extending outwardly through the elongated hole 107. The movable assembly 20 includes the container 201 and the massage member 202 retained therein. The connecting member 108 includes the protrusion, and the container 201 includes the connecting groove. The user aligns the insertion portion 221 of the connecting groove with the protrusion, inserts the protrusion into the groove, and then rotates the movable assembly 20 relative to the drive assembly 10 by a predetermined angle to shift the protrusion into the clamping portion 2012. Thereafter, activation of the motor causes the linear reciprocating mechanism 119 to drive the connecting member 108 back and forth along the first direction D1, thereby moving the movable assembly 20 along the exterior contact surface 111 and reciprocating the massage channel 211 relative to the inserted phallic structure. After use, the user rotates the movable assembly 20 in an opposite direction and removes it for cleaning or replacement.

A second implementation variant will now be described in one embodiment, shown in FIG. 2-3 and 13, the exterior contact surface 111 is a first concave curved surface 1131 having a curvature adapted to an outer sidewall of the movable assembly 20 in the first direction D1. By configuring the exterior contact surface 111 as a concave curved surface, the movable assembly 20 may be guided, supported, and stabilized during reciprocation. The outer sidewall of the movable assembly 20 may correspondingly be convex, partially cylindrical, partially elliptical, or otherwise complementary to the contour of the exterior contact surface 111. In some embodiments, this surface conformity may reduce wobble, distribute load, and improve comfort and perceived quality during operation.

In some embodiments, because the exterior contact surface 111 is recessed inwardly, at least a portion of the movable assembly 20 may be received within a concave profile region defined by the drive assembly 10. Accordingly, an overall external contour and occupied space of the combined structure may be reduced, thereby improving compactness of the device. Such arrangement may facilitate storage, transportation, carrying, and handheld operation of the device.

In some embodiments, the concave curved configuration may further improve ergonomic conformity between the drive assembly 10 and the movable assembly 20, thereby enhancing user comfort and improving visual continuity and integrated appearance of the product.

In a further embodiment, the drive assembly 10 further comprises a third end cover 113 disposed on a side of the drive assembly 10 adjacent to the insertion opening. A cover surface of the third end cover 113 may be a second concave curved surface 1132 configured to provide clearance for a scrotum of the male human when the phallic structure is inserted into the massage channel 211. In some embodiments, the first concave curved surface 1131 of the housing 106 and the second concave curved surface 1132 of the third end cover 113 are connected through a transition surface 1133, which may be a third concave curved surface. The combined contour may define an ergonomic receiving region near the insertion end of the device. Optionally, the transition surface 1133 may be smoothly blended to reduce local pressure concentration. In one implementation, the second concave curved surface 1132 may have a greater curvature depth than the first concave curved surface.

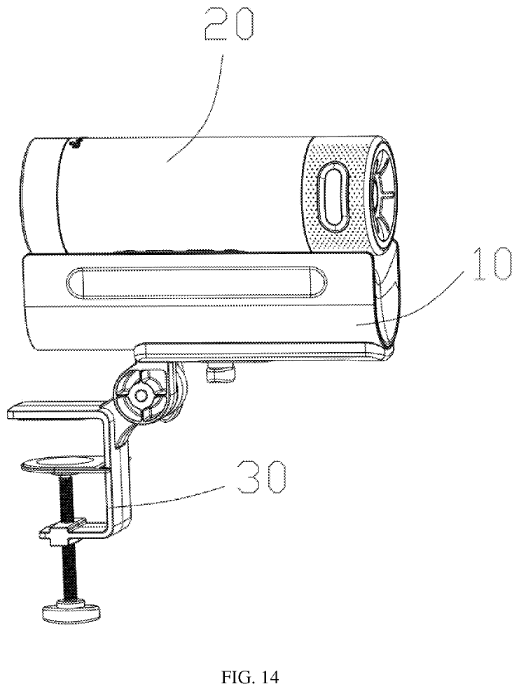

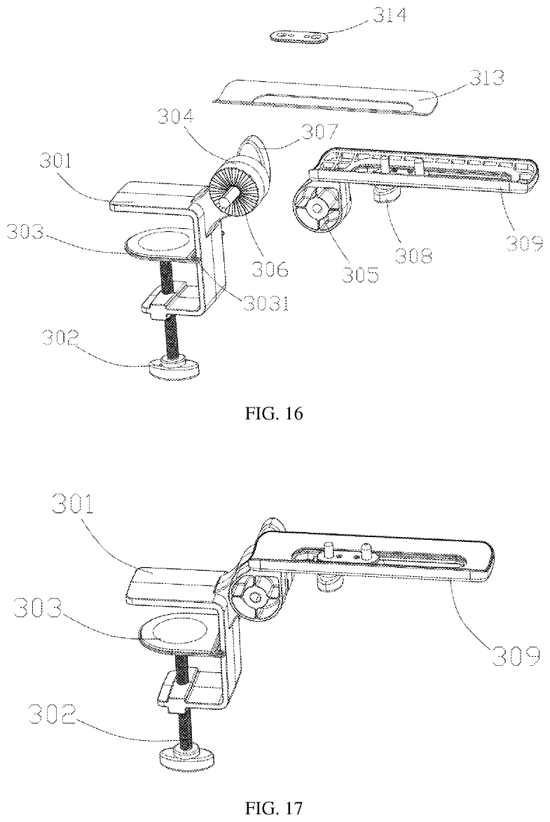

A third implementation variant will now be described in an exemplary embodiment, referring to FIGS. 14-17, the ejaculation stimulating device also includes a fixing component 30 connected to the driving assembly 10. The fixing component 30 comprises a channel-shaped clamping part 301 and a first bolt 302. A first screw hole is provided on one side wall of the channel-shaped clamping part 301, and after the first bolt 302 is screwed into the first screw hole, it extends between the two side walls of the channel-shaped clamping part 301. The end of the portion of the first bolt 302 that extends between the two side walls of the channel-shaped clamping part 301 is connected to a clamping plate 303. A clamping area is formed between the clamping plate 303 and the opposite side wall of the channel-shaped clamping part 301, which can clamp any planar object at various heights. By rotating the first bolt 302 left or right, the clamping plate 303 moves to adjust the size of the clamping area. At the same time, by tightening the first bolt 302, the ejaculation stimulating device can be fixedly connected to the planar object, thereby freeing the hands of the male user to enhance the experience. The clamping plate 303 has two extending parts 3031 that extend towards the bottom of the channel-shaped clamping part 301 on the side facing the bottom of the channel-shaped clamping part 301. The two extending parts 3031 are spaced apart on both sides of the channel-shaped clamping part 301 and are in contact with it. The contact between the extending parts 3031 of the clamping plate 303 and the channel-shaped clamping part 301 provides guidance for the vertical movement of the clamping plate 303. The channel-shaped clamping part 301 is offset from the central position of the container 201 in the movable component 20, which prevents the container 201 from colliding with sensitive areas of the male user when the ejaculation stimulating device is fixed on an object.

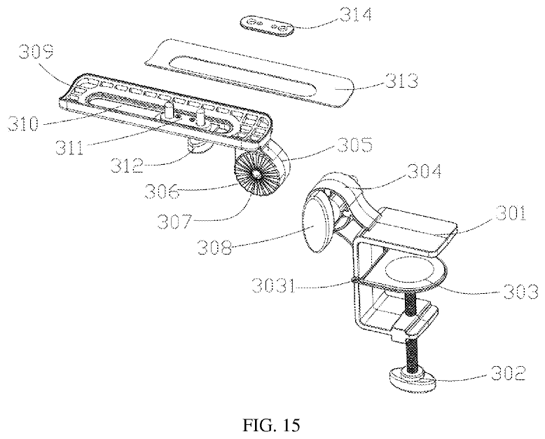

In at least some exemplary embodiments, referring to FIGS. 15-17, the fixing component 30 also includes a rotational connecting component, which consists of a first rotating part 304 and a second rotating part 305. The first rotating part 304 is connected to the channel-shaped clamping part 301, while the second rotating part 305 is connected to the driving assembly 10. Both the first rotating part 304 and the second rotating part 305 are equipped with engaging teeth 306 and a second screw hole 307, into which a second bolt 308 is screwed. When the second bolt 308 is tightened, the engaging teeth 306 on the first rotating part 304 mesh with those on the second rotating part 305. When the second bolt 308 is loosened, the engaging teeth 306 on both rotating parts disengage, allowing for relative rotation between the first rotating part 304 and the second rotating part 305. By incorporating the rotational connecting component, the angles of the driving assembly 10 and the movable component 20 can be adjusted, enabling the male user to tailor the angle according to their desired position.

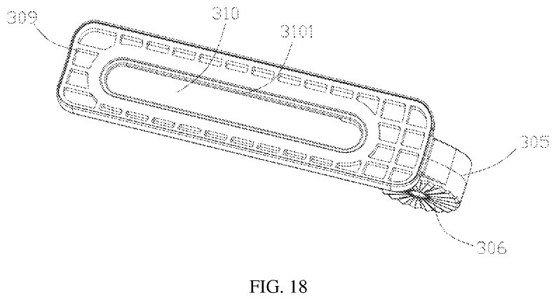

In this embodiment, referring to FIGS. 15-18, a locking plate 309 is connected to the second rotating part 305, which is provided with an elongated through hole 310 arranged along its length. The center of the hole wall (the “center” refers to the position between the upper and lower edges of the hole wall) is equipped with a flange 3101 that protrudes towards the center. The fixing component 30 also includes a pressing plate 311, which has a third screw hole. An installation hole 115 is provided on the U-shaped housing 106, and a lower mounting bracket 116 is located within the U-shaped housing 106. A fourth screw hole is set on the lower mounting bracket 116 opposite the installation hole 115. By tightening a third bolt 312, which is passed through the installation hole 115 on the U-shaped housing 106 and screwed into the fourth screw hole on the lower mounting bracket 116, the pressing plate 311 can be pressed tightly against the flange 3101 of the locking plate 309, thereby compressing the locking plate 309 against the driving assembly 10.

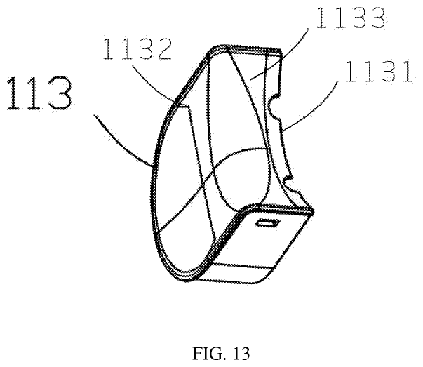

In at least some exemplary embodiments, referring to FIG. 12, the lower mounting bracket 116 is placed within a receiving cavity to provide mounting support for the various components inside. The bottom end of the upper mounting bracket 105 and the top end of the lower mounting bracket 116 abut each other. The lower mounting bracket 116 features a motor installation slot, and two baffles 117 are spaced apart on one side of the motor installation slot. Each baffle 117 contains two supporting slots, with both ends of the guide rod 104 supported in the opposing supporting slots of the two baffles 117. Additionally, the lower mounting bracket 116 is equipped with a battery installation slot and an area for mounting the control circuit board, where a battery 118 is installed within the battery installation slot, and a control circuit board 119 is fitted in the designated area, with wires connecting the battery 118 to the control circuit board 119. There is also an exposed socket on the lower mounting bracket 116 for a charging interface, which aligns with the installation hole 115 on the U-shaped housing 106 for easy charging. Furthermore, a plug cover 120 is provided at the installation hole 115 on the U-shaped housing 106, made of either soft or hard material. The third bolt 312 must pass through this plug cover 120 during insertion into the lower mounting bracket 116. Consequently, the plug cover 120 has a through hole for the third bolt 312. To charge it, the plug cover 120 can be removed to expose the socket.

In at least some exemplary embodiments, referring to FIGS. 14-16, a first gasket 313 is placed between the locking plate 309 and the U-shaped housing 106 of the driving assembly 10, and/or a second gasket 314 is set between the pressing plate 311 and the lower mounting bracket 116. The locking plate 309 has a curvature that matches the shape of the U-shaped housing 106, which facilitates the installation of the driving assembly 10.

The invention is not limited to personal stimulation use. In some embodiments, the device may be adapted for semen collection, diagnostic support, therapeutic routines, assisted fertility procedures, rehabilitation, laboratory protocols, educational demonstration, or veterinary analogs, subject to applicable law and ethical standards. The massage member 202 may be made sterile, packaged individually, color-coded, size-coded, or serialized. In some embodiments, data regarding usage patterns, motor load, cycle count, or service interval may be stored in memory and displayed or transmitted.

Although certain prior references may disclose stimulation devices, sleeves, or motorized arrangements, the present disclosure provides support for claim drafting directed to, among other things, the externally reciprocating movable assembly, release movement along a different direction than the reciprocating motion, the elongated-hole-and-seal drive interface, the particular protrusion-and-groove coupling relationship, the massage-member retention structure, and the concave ergonomic support surfaces. The disclosure intentionally describes these features both separately and in combination so that different claim sets may be pursued during prosecution or in continuing applications.

In some embodiments, individual features described as belonging to one embodiment may be used in another embodiment. For instance, the annular latch structure for retaining the massage member 202 may be combined with a threaded detachable coupling 40. The concave curved exterior contact surface 111 may be used with any of the drive units disclosed herein. The deformable sealing member 114 may be combined with manually powered or electronically controlled reciprocation systems. Sensor-based control may be incorporated into any mechanical arrangement described. Likewise, the third end cover 113 may be omitted where anatomical clearance is not a design priority, or may be replaced by another contouring structure.

Unless otherwise indicated, terms such as “substantially,” “approximately,” and “generally” are intended to allow for manufacturing tolerances, functional deviations, and practical implementation variation. The use of exemplary ranges is not intended to exclude values outside those ranges unless expressly stated. Features described in relation to “one embodiment,” “some embodiments,” “a preferred embodiment,” or similar language are not necessarily required in all embodiments.

It will be further understood that any of the disclosed structures can be implemented as one or more modules, and that module boundaries may vary. For example, a “drive unit” may include separate motor and transmission subassemblies or may be integrated as a single actuator module. A “movable assembly” may include a container and massage member as separately replaceable parts or as a unitary cartridge. A “controller” may be implemented by dedicated circuitry, programmable logic, firmware, software executed by one or more processors, or combinations thereof. A “memory” may include volatile memory, non-volatile memory, or both.

The foregoing detailed description is provided to illustrate various embodiments and to enable one of ordinary skill in the art to make and use the invention. It is not intended to limit the scope of the invention, which is defined by the claims that may be presented in this application or in one or more continuing applications. Numerous modifications, substitutions, additions, and rearrangements may be made without departing from the spirit and scope of the invention.

1. An ejaculatory stimulation device, comprising:
a drive assembly comprising a housing having an exterior contact surface extending along a first direction, and a drive unit supported by the housing;
a movable assembly disposed entirely outside the housing and comprising a massage member having a massage channel dimensioned to receive a phallic structure and an insertion opening configured to permit insertion and withdrawal of the phallic structure; and
a detachable coupling between the movable assembly and the drive unit of the drive assembly,
wherein the drive unit is configured to drive the movable assembly to move relative to the housing along the exterior contact surface in the first direction such that the massage channel stimulates the phallic structure,
wherein the detachable coupling is configured to permit decoupling of the movable assembly from the housing by relative movement in a second direction different from the first direction, and
wherein the first direction is aligned with an axial direction of the phallic structure when received in the massage channel.

2. The device of claim 1, wherein the detachable coupling comprises a snap engagement or a threaded engagement configured to retain the movable assembly on the exterior contact surface during the movement.

3. The device of claim 1, wherein the second direction is a rotational direction, and the detachable coupling is configured to release after relative rotation between the movable assembly and the housing by a predetermined angle.

4. The device of claim 3, wherein the relative rotation is circumferential rotation about an axis of the movable assembly that is substantially parallel to the axial direction of the phallic structure.

5. The device of claim 3, wherein the second direction is substantially perpendicular to the first direction or forms a predetermined non-zero angle with the first direction.

6. The device of claim 1, wherein the housing defines an elongated hole, wherein a portion of the drive unit extends from an interior of the housing through the elongated hole to an exterior of the housing and is coupled to the movable assembly, and wherein the portion of the drive unit is configured to slide along the elongated hole to drive the reciprocation of the movable assembly.

7. The device of claim 6, further comprising a deformable sealing member disposed at an edge of the elongated hole and configured to inhibit liquid from entering the housing through the elongated hole.

8. The device of claim 1, wherein one of the drive unit and the movable assembly comprises a protrusion, and the other of the drive unit and the movable assembly comprises a connecting groove configured to receive the protrusion.

9. The device of claim 8, wherein the protrusion comprises a vertical plate and a horizontal plate connected to the vertical plate, wherein the connecting groove comprises an insertion portion and a clamping portion, and wherein the horizontal plate is insertable through the insertion portion and retainable in the clamping portion by relative rotation between the movable assembly and the housing.

10. The device of claim 8, wherein the drive unit comprises a connecting member protruding outwardly from the exterior contact surface, and the movable assembly defines the connecting groove configured to receive at least a portion of the connecting member.

11. The device of claim 1, wherein the drive unit comprises a motor fixed within the housing and a linear reciprocating mechanism coupled to the motor, the linear reciprocating mechanism being configured to convert rotational motion of an output shaft of the motor into linear reciprocating motion transmitted to the movable assembly.

12. The device of claim 1, wherein the movable assembly further comprises a container configured to receive and secure at least a portion of the massage member, wherein the massage member comprises a head portion and a body portion smaller than the head portion, wherein the insertion opening is formed in an end surface of the head portion, wherein the head portion includes an annular groove, and wherein the container includes an annular inner latch configured to engage the annular groove.

13. The device of claim 12, wherein the body portion includes a plurality of protruding ribs spaced apart on an outer sidewall thereof and configured to abut an inner wall of the container.

14. The device of claim 1, wherein the exterior contact surface comprises a first concave curved surface having a curvature adapted to an outer sidewall of the movable assembly along the first direction.

15. The device of claim 14, further comprising an end cover disposed on a side of the housing adjacent to the insertion opening, the end cover having a second concave curved surface configured to provide clearance for a scrotum of a male user during insertion of the phallic structure into the massage channel.

16. The device of claim 15, wherein the first concave curved surface and the second concave curved surface are connected by a transition surface that is concavely curved.

17. An ejaculatory stimulation device, comprising:
a drive assembly comprising a housing having an exterior contact surface extending along a first direction, and a drive unit supported by the housing;
a movable assembly disposed entirely outside the housing and comprising a massage member having a massage channel dimensioned to receive a phallic structure and an insertion opening configured to permit insertion and withdrawal of the phallic structure; and
a detachable coupling between the movable assembly and the drive unit of the drive assembly,
wherein the drive unit is configured to drive the movable assembly to move relative to the housing along the exterior contact surface in the first direction such that the massage channel stimulates the phallic structure,
wherein the first direction is aligned with an axial direction of the phallic structure when received in the massage channel, and
wherein the exterior contact surface comprises a first concave curved surface having a curvature adapted to an outer sidewall of the movable assembly along the first direction.

18. The device of claim 17, further comprising an end cover disposed on a side of the housing adjacent to the insertion opening, the end cover having a second concave curved surface dimensioned to provide clearance for a scrotum of a male user during insertion of the phallic structure into the massage channel.

19. The device of claim 18, wherein the first concave curved surface and the second concave curved surface are connected by a transition surface that is concavely curved.

20. The device of claim 19, wherein a curvature of the transition surface gradually changes from the curvature of the first concave curved surface to the curvature of the second concave curved surface, such that a smooth transition is formed between the first concave curved surface and the second concave curved surface.
